(19) United States
(12) Patent Application Publication
(10) Pub. No.: US 2009/0298562 A1
(43) Pub. Date: Dec. 3, 2009

(54) PORTABLE COMMUNICATION DEVICE

(75) Inventor: Hyun-Su LIM, Yongin-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/476,605

(22) Filed: Jun. 2, 2009

(30) Foreign Application Priority Data
Jun. 2, 2008 (KR) 10-2008-0051825

(51) Int. Cl. H04M 1/00

(52) U.S. Cl. 455/575.4

(57) ABSTRACT

A portable communication apparatus is provided. The portable terminal includes a first housing, a second housing rotatably assembled with the first housing in a state where the second housing faces the first housing, and third and fourth housings disposed within the first housing, the third and fourth housings sliding the second housing and being inserted into/drawn from both sides of the first housing according to the sliding.

### PRIORITY

This application claims priority under 35 U.S.C. §119(a) to an application entitled “Portable Communication Device” filed in the Korean Industrial Property Office on Jun. 2, 2008 and assigned Serial No. 10-2008-0051825, the contents of which are herein incorporated by reference.

### BACKGROUND OF THE INVENTION

1. Field of the Invention

The present invention relates to a portable communication apparatus, in which housings of the portable communication apparatus can be inserted into or drawn from both sides of one housing when another housing slides.

2. Description of the Related Art

In general, portable communication apparatuses include electronic devices that allow users to wirelessly communicate with other users. Various types of service contents, such as voice call service, short text message sending, mobile banking, TV audition, on-line game, video on demand, etc., can be provided to users through portable communication apparatuses.

Conventional portable communication apparatuses are classified into various types according to their external appearance. For example, portable communication apparatuses are classified into bar-type, flip-type and folder-type apparatuses according to the external appearance thereof. The bar-type apparatus includes a single housing having a bar-shape. The flip-type apparatus includes a flip rotatably coupled to a bar-type housing by means of a hinge device. The folder-type apparatus includes a folder rotatably and foldably coupled to a single bar-type housing by means of a hinge device.

More specifically, sliding-type communication apparatuses have two housings, which are opened by sliding in a longitudinal direction. The above-described communications apparatuses, which are classified into various types, are well-known by those skilled in the art.

Moreover, a detailed configuration of a sliding-type portable communication apparatus is disclosed in Korean Patent Application No. 2002-71911, assigned to the present assignee. The sliding-type portable communication apparatus disclosed in Korean Patent Application No. 2002-71911 has a sliding module allowing a pair of housings to slide, and the sliding module is assembled with each housing so as to implement the sliding operation of each housing.

However, even though mobile communication services have gradually diversified, and products also become devices having multimedia functions, the shape of the conventional portable communication apparatus still includes the shape of the conventional folder-type and sliding-type communication apparatus. Also, users' demands have also diversified as the general use of conventional communication apparatuses increases. However, the shape of the conventional portable communication apparatus doesn't satisfy the users' various demands.

Moreover, a conventional sliding-type portable communication apparatus has a structure where one housing slides in only one direction so that a length of the housing, which corresponds to ½ length of the other fixed housing, is opened in a state where the two housings face each other. Therefore, there is a disadvantage in that the user is only able to use a limited area provided on the fixed housing. Also, due to a small number of keys allocated to the limited area of the housing, it is inconvenient to operate the keys for inputting texts, playing game, etc.

### SUMMARY OF THE INVENTION

Accordingly, the present invention has been made to solve at least the above-mentioned problems occurring in the prior art. The present invention further provides a portable communication apparatus having a structure where housings of the portable communication apparatus can be inserted into or drawn from both sides of one housing when another housing slides so that various shapes of the apparatus are possible and usage effect can be improved.

Also, the present invention provides a portable communication apparatus having a structure where housings of the portable communication apparatus are inserted into or drawn from both sides of one housing when another housing slides so that a plurality of keys and a large-sized displaying device, which allows the apparatus to be used in various fields, are included therein, and the user can conveniently operate the keys with both hands when the keys are used to input text and to play games.

According to one aspect of the present invention, a portable communication apparatus is provided. The portable communication apparatus includes a first housing; a second housing slidably assembled with the first housing in a state where the second housing faces the first housing; and third and fourth housings disposed within the first housing, the third and fourth housings for sliding towards and away from the second housing and being inserted into and drawn from both sides of the first housing by sliding.

According to another aspect of the present invention, a portable communication apparatus is provided. The portable communication apparatus includes a first housing; a second housing slidably assembled with the first housing in a state where the second housing faces the first housing; third and fourth housings disposed within the first housing, the third and fourth housings for sliding towards and away from the second housing and for being inserted into and drawn from both sides of the first housing by sliding; a module positioned between the first and second housings, the module allowing the second housing to slide and allowing the third and fourth housings to be inserted into/drawn from the first housing according to a sliding of the second housing with respect to the first housing; and a locking module included in the module, the locking module locking or releasing the third and fourth housings to be inserted into/drawn from the first housing when the second housing slides.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view illustrating the configuration of a portable communication apparatus according to one embodiment of the present invention;

FIG. 2 is an exploded perspective view of an enlarged part A of FIG. 1;

FIG. 3 is an exploded perspective view illustrating a disassembled state of a portable communication apparatus according to one embodiment of the present invention;

FIG. 4 is an exploded perspective view illustrating an assembled state of a portable communication apparatus according to one embodiment of the present invention;

FIG. 5 is a perspective view illustrating the use procedure of a portable communication apparatus according to an embodiment of the present invention;

FIG. 6 is a side sectional view illustrating the use procedure of a portable communication apparatus according to an embodiment of the present invention;

FIG. 7 is a perspective view illustrating the use state of a locking module of a portable communication apparatus according to an embodiment of the present invention;

FIG. 8 is a side sectional view illustrating the use state of a locking module of a portable communication apparatus according to an embodiment of the present invention;

FIG. 9 is a perspective view illustrating a state where a second housing of the portable communication apparatus according to an embodiment of the present invention slides;

FIG. 10 is a side sectional view illustrating a state where a second housing of the portable communication apparatus according to an embodiment of the present invention slides;

FIG. 11 is a perspective view illustrating a state where second, third, fourth housings of the portable communication apparatus according to an embodiment of the present invention slide;

FIG. 12 is a plane view illustrating a state where second, third, and fourth housings of the portable communication apparatus according to an embodiment of the present invention slide;

FIG. 13 is a perspective view illustrating a state where second, third, and fourth housings of the portable communication apparatus according to an embodiment of the present invention slide;

FIG. 14 is a side sectional view illustrating a state where a locking module before it is operated when the second, third, and fourth housings of the portable communication apparatus according to an embodiment of the present invention slide to their original positions;

FIG. 15 is a perspective view of the portable communication apparatus, in which an operational procedure of a locking module when the second, third, and fourth housings of the portable communication apparatus according to an embodiment of the present invention slide to their original positions is shown;

FIG. 16 is a side sectional view of a locking module, in which an operational procedure of the locking module when the second, third, and fourth housings of the portable communication apparatus according to an embodiment of the present invention slide to their original positions is shown;

FIG. 17 is a perspective view of the portable communication apparatus, in which operational states of the first and second locking modules when the second, third, and fourth housings of the portable communication apparatus according to an embodiment of the present invention slide to their original positions are shown;

FIG. 18 is a side sectional view of the first and second locking modules, in which operational states of the first and second locking modules when the second, third, and fourth housings of the portable communication apparatus according to an embodiment of the present invention slide to their original positions are shown;

FIG. 19 is a perspective view of the portable communication apparatus, in which the state of the locking module after it has been operated when the second, third, and fourth housings of the portable communication apparatus according to an embodiment of the present invention slide to their original positions is shown; and

FIG. 20 is a side sectional view showing a state of the locking module after it has been operated when the second, third, and fourth housings of the portable communication apparatus according to an embodiment of the present invention slide to their original positions is shown.

### DETAILED DESCRIPTION OF PREFERRED EMBODIMENTS

Hereinafter, an embodiment of the present invention will be described with reference to the accompanying drawings.

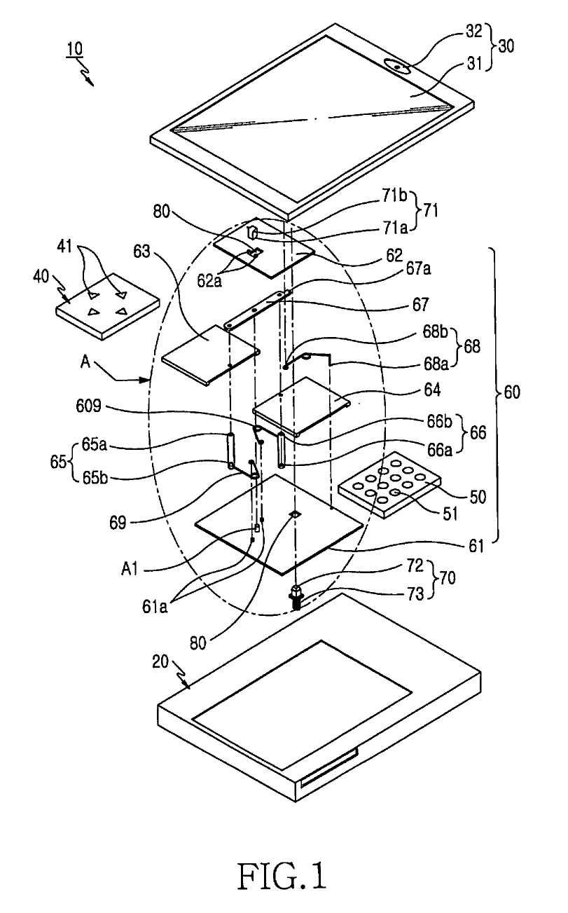

As shown in FIGS. 1 to 4, a portable communication apparatus 10 includes first, second, third, and fourth housings 20, 30, 40, and 50. The first housing 20 allows the second housing 30 to slide while facing the second housing 30, which will be described below, the second housing 30 is slidably assembled with the first housing 20 facing the first housing 20, and the third and fourth housings 40 and 50 are positioned within the first housing 20 in such a manner that they can slide from the second housing 30 and be inserted into/drawn from both sides of the first housing 20 according to the sliding operation.

As shown in FIG. 1, the first housing 20 includes a microphone device (not shown), a camera module (not shown), and a 3×4 keypad (not shown), the second housing 30 includes a large display 31 and a speaker 32, and the third housing 40 includes a 4-direction key 41, a navigation key (not shown), and keys used for playing games (not shown). Also, the fourth housing 50 includes at least one keypad 51 having keys arranged thereon.

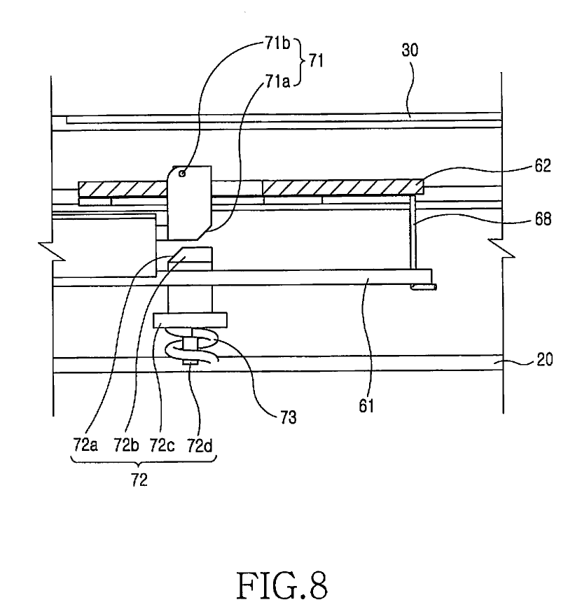

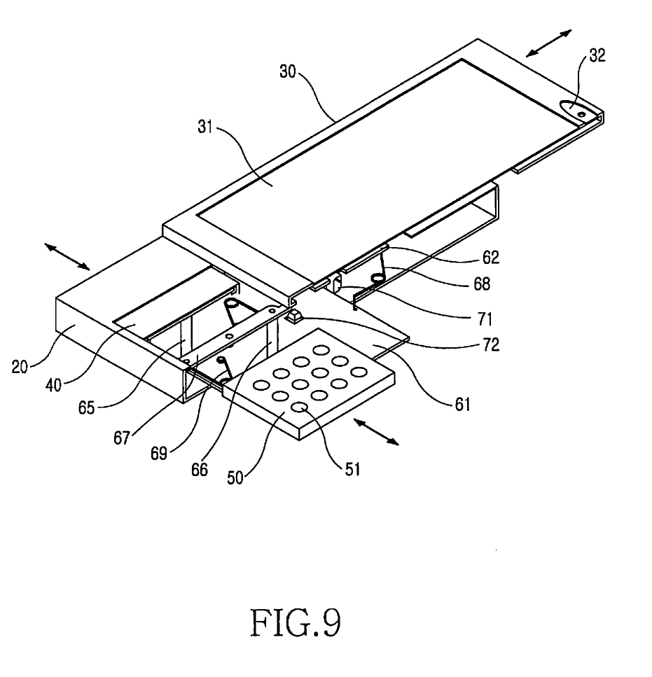

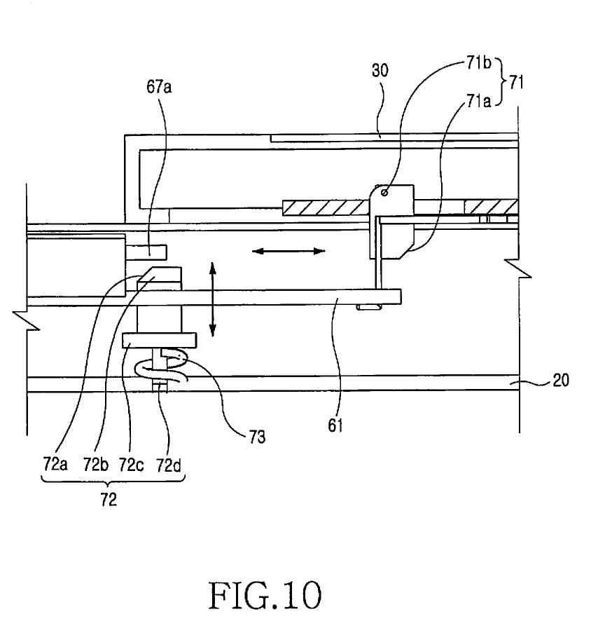

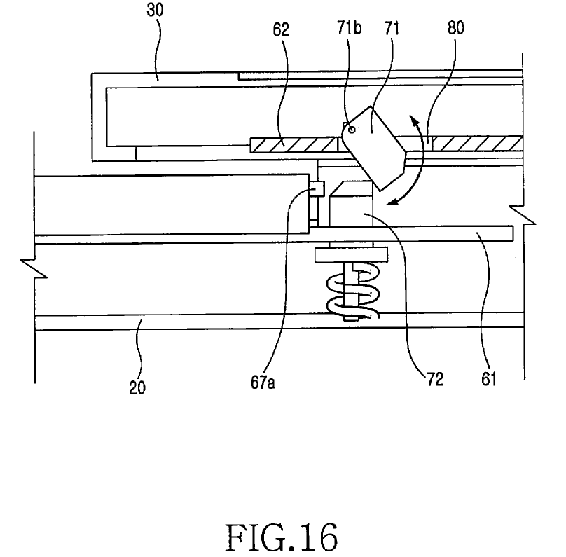

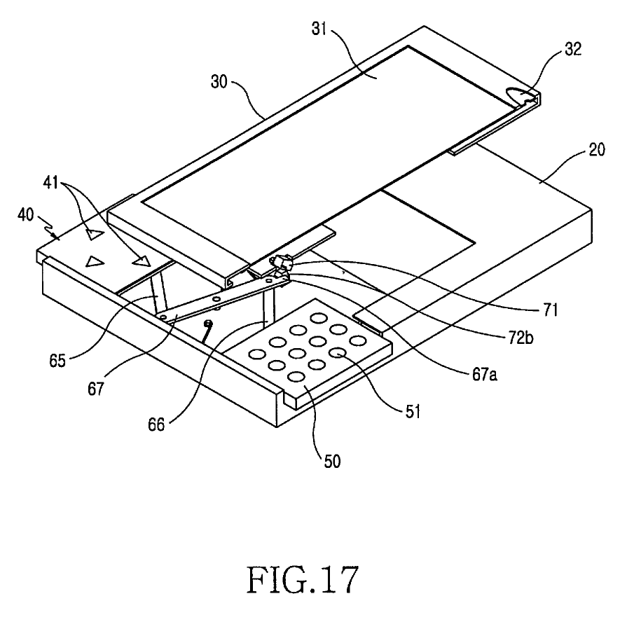

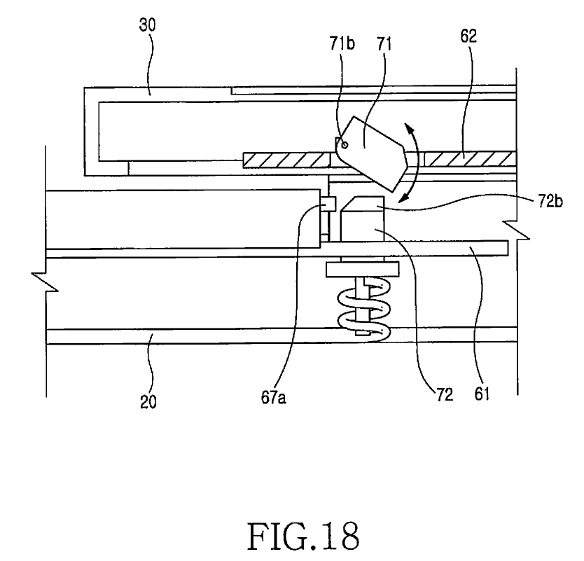

Moreover, as shown in FIGS. 1 to 20, a module 60 of the portable communication apparatus 10 is disposed between the first and second housings 20 and 30 so as to allow the second housing 30 to slide and allow the third and fourth housings 40 and 50 to be inserted into/drawn from the first housing 20 according to sliding of the second housing 30. A locking module 70 of the portable communication apparatus 10 is included in the module 60 so as to allow the third and fourth housings 40 and 50 to be locked or released so that they can be inserted into/drawn from the first housing according to sliding of the second housing 30.

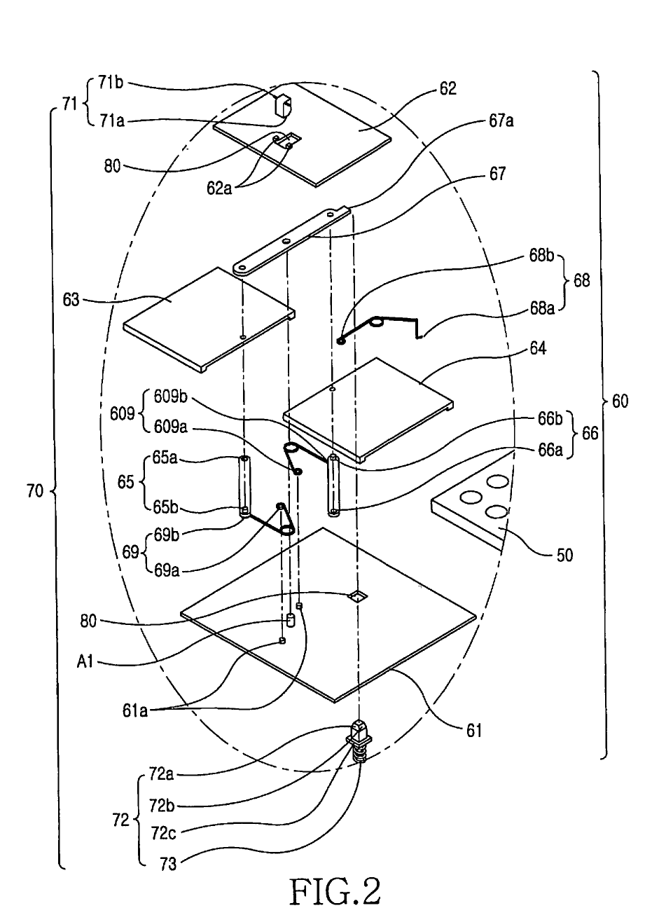

As shown in FIGS. 1 and 2, the module 60 includes a base member 61, first, second, and third sliding members 62, 63, and 64, rotation connecting bars 65 and 66, a rotation link member 67, and first, second, and third elastic members 68, 69, and 609. The base member 61 is mounted on the first housing 20 in such a manner that the base member has the first, second, and third sliding members 62, 63, and 64, the rotation connecting bars 65 and 66, the rotation link member 67, the first, second, and third elastic members 68, 69, and 609. The first sliding member 62 is mounted on the second housing 30 in such a manner that it is stacked on the base member 61 so as to allow the second housing 30 to slide on the first housing 20. The second and third sliding members 63 and 64 are mounted on the third and fourth housings 40 and 50, respectively, in such a manner that they are stacked on the based member 61, so as to allow the third and fourth housings 40 and 50 to be inserted into/drawn from both sides of the first housing 20 through their sliding operation, respectively. The rotation connecting bars 65 and 66 are connected with the second and third sliding members 63 and 64 and the rotation link member 67, respectively, so that the rotation connecting bars slide according to the rotation of the rotation link member 67, which will be described below, so as to allow the second and third sliding members 63 and 64 to slide.

As shown in FIGS. 1, 2, and 5 to 20, one end 65a of the first rotation connecting bar 65 and one end 66a of the second rotation connecting bar 66 are rotatably connected with the second and third sliding members 63 and 64. The other end 65b of the first rotation connecting bar 65 and the other end 66b of the second rotation connecting bar 66 are rotatably connected with the rotation link member 67. The rotation link member 67 is connected with the first and second rotation connecting bars 65 and 66 and is disposed between the first, second, and third sliding members 62, 63, and 64 so as to allow the second and third sliding members 63 and 64 to slide in such a manner that the rotation link member 67 is released from a locked state, rotates about a rotational shaft A1, and also rotates the first and second rotation connecting bars 65 and 66 when the first sliding member 62 slides. The two ends of the rotation link member 67 are rotatably connected with ends of the first and second rotation connecting bars 65 and 66, respectively, and a latching member 67a is formed at one end of the rotation link member 67 so as to allow the rotation link member 67 to be locked in or released from the second locking part 72 of the locking module 70 when it makes contact with the second locking part 72. The first elastic member 68 is disposed between the base member 61 and the first sliding member 62, which provides an elastic force allowing the first sliding member 62 to slide. The second and third elastic members 69 are disposed between the second and third sliding members 63 and 64 so as to provide elastic force allowing the rotation link member 67 to rotate.

As shown in FIGS. 1, 2, 9, and 12, one end 68a of the first elastic member 68 is connected with the base member 61, and the other end 68b of the first elastic member 68 is connected with the first sliding member 62 so as to provide elastic force allowing the first sliding member 62 to be slide. Each end 69a and 609a of the second and third elastic members 69 is rotatably connected with each protuberance 61a formed on the base member 61, and the other end 69b and 609b of each of the second and third elastic member 69 and 609 is connected with the rotation link member so as to allow the rotation link member 67 to be rotated due to elastic force

As shown FIGS. 1, 2, and 5 to 20, the locking module 70 includes first and second locking parts 71 and 72, and a locking elastic member 73. The first locking part 71 is rotatably assembled with the first sliding member 62 so as to make contact with the second locking part 72, which will be described below, when the first sliding member 62 slides. The second locking part 72 is included in the base member 61 and moves upward and downward to be locked in and released, respectively, from the latching member 67a formed on the rotation link member 67 according to its contact with the first locking part when the first locking part 71 together with first sliding member 62 slides, so that the second and third sliding members 63 and 64 are inserted into/drawn from the first housing through sliding. The locking elastic member 73 is included in a lower part of the second locking part 72 so as to provide elastic force allowing the second locking part 72 to move upward and downward.

As shown in FIGS. 1, 2, 5 to 10, an inclined movement surface 71a is formed on one end of the first locking part 71 so as to press the second locking part 72 to the lower side in such a manner that the inclined movement surface is guided along a first inclined guide surface 72a formed on the second locking part 72 when the first sliding member 62 slides.

A locking rotation part 71b is formed at the other end of the first locking part 71, such that the locking rotation part makes contact with the second locking part 72 and moves along through a rotation when the first sliding member 62 is slid to its original position, and the locking rotation part 71b has a pair of rotation protuberances so as to be rotatably assembled with a pair of hinge arms 62a formed on the first sliding member 62.

As shown in FIGS. 1, 2, and 11 to 20, the second locking part 72 includes first and second inclined guide surfaces 72a and 72b, an escape prevention member 72c, and an elastic guide part 72d. The first inclined guide surface 72a is formed at a part of the second locking part 72, which corresponds to the inclined movement surface 71a of the first locking part 71. Therefore, the first inclined guide surface 72a moves while guiding the inclined movement surface 71a when it makes contact with the inclined movement surface 71a so as to allow the second locking part 72 to move upward and downward and release the second locking part 72 from the latching member 67a of the rotation link member 67 so that the second and third sliding members 63 and 64 can be inserted into/drawn from the first housing. The second inclined guide surface 72b is formed on a part of the second locking part 72 that is adjacent to the first inclined guide surface 72a, which allows the second locking part 72 to be latched to the latching member 67a in such a manner that the second inclined guide surface 72b makes contact with the latching member 67a of the rotation link member 67, and the second inclined surface 72b is also guided so as to move the second locking part 72 upward and downward when the second and third sliding members 63 and 64 are inserted. The escape prevention member 72c is formed on a lower part of the second inclined guide surface 72b so as to prevent the second locking part 72 from escaping out of the base member 61 when the second locking part 72 moves upward and downward, and an elastic guide part 72d is formed on the lower side of the escape prevention member 72c so as to be assembled with the locking elastic member 73.

As shown in FIG. 1, an operational hole 80, which provides space allowing the first and second locking parts 71 and 72 to be operated, is formed at the base member 61 and the first sliding member 62.

The operational procedure of a portable communication apparatus structured as described above according to an embodiment of the present invention will be described in detail with reference to FIGS. 1 to 20.

As shown in FIGS. 1 to 4, the portable communication apparatus 10 includes first, second, third, and fourth housings 40 and 50, a module 60, and a locking module 70.

As shown in FIGS. 1 to 20, the module 60 includes a base member 61, and further includes first, second, and third sliding members 62, 63, and 64, first and second rotation connecting bars 65 and 66, a rotation link member 67, first, second, and third elastic members 68,69 and 609. The locking module 70 includes first and second locking parts 71 and 72, and a locking elastic member 73. The locking module 70 includes first, second, and third sliding members 62, 63, and 64, and first and second rotation connecting bars 65 and 66, and the rotation link member 67, and first, second, and third elastic members 68,69 and 609, which are stacked on the base member 61.

As shown in FIGS. 1, 3, and 4, the second locking part 72 is assembled in such a manner that the second locking part 72 extends through the operational hole 80 formed on the base member 61. Also, the first locking part 71 extends through the operational hole 80 formed on the first sliding member 62, and the locking rotation part 71b of the first locking part 71 is rotatably assembled with a pair of hinge arms 62a formed at the first sliding member 62.

The locking rotation member 71b includes a pair of rotation protuberances.

As shown in FIGS. 1 to 4, ends 65a and 66a of the first and second rotation connecting bars 65 and 66 are rotatably connected with the second and third sliding members 63 and 64, respectively, and the other ends 65b and 66b thereof are rotatably connected with the rotation link member 67. One end 68a of the first elastic member 68 is connected with the base member 61, and the other end thereof is connected with the first sliding member 62. One end of each of the second and third elastic members 69 and 609 is rotatably connected with each protuberance 61a formed on the base member 61, and the other end 69b of each elastic member is connected with the rotation link member 67.

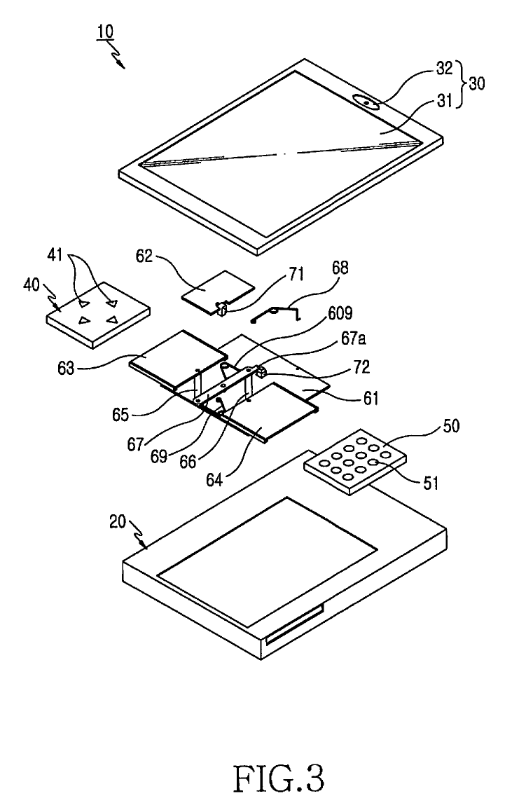

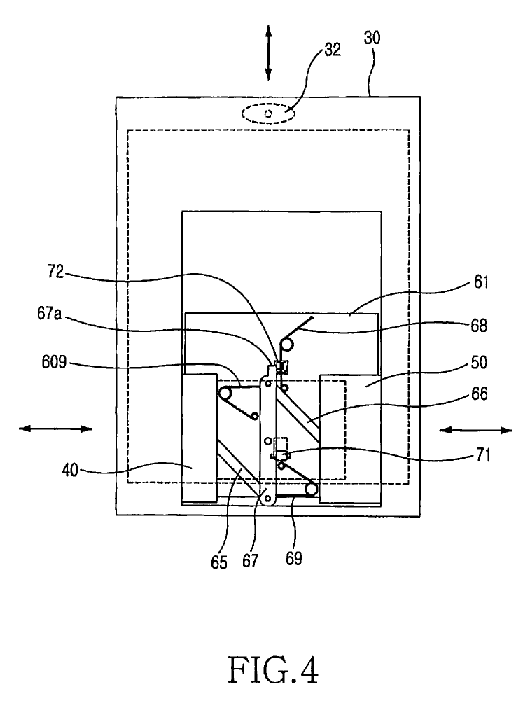

At this state, as shown in FIGS. 3 and 4, the base member 61 is mounted on the first housing 20, the first sliding member 62 is mounted on the second housing 30, the second sliding member 63 is mounted on the third housing 40, and the third sliding member 64 is mounted on the fourth housing 50.

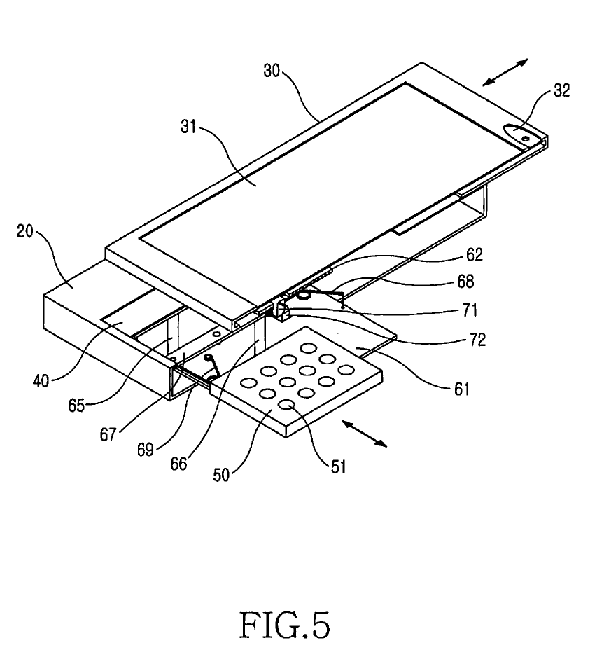

Herein, as shown in FIGS. 5 to 10, when the second housing 30 is moved by the user in an upwards direction from the first housing 20 in a state where the second housing faces the first housing 20, the first sliding member 62 slides together with the first locking part 71.

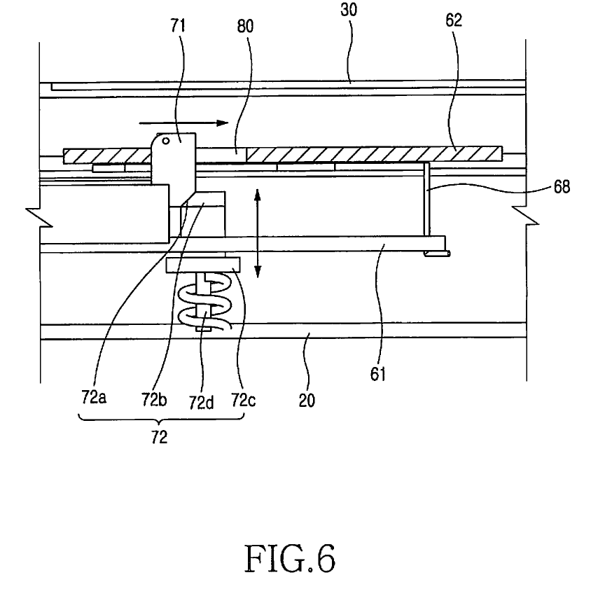

At this time, as shown in FIGS. 5 and 6, the inclined movement surface 71a of the first locking part 71 slides together with the first locking part to make contact with the first inclined guide surface 72a of the second locking part 72. The inclined movement surface 71a is guided along the first inclined guide surface 72a, and the second locking part 72 is moved downward by the first inclined guide surface 72a.

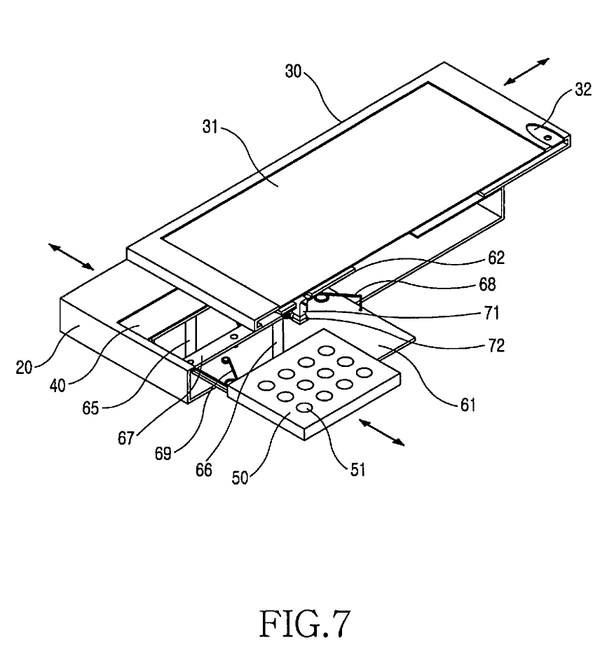

At this time, as shown in FIGS. 7 to 10, the latching member 67a of the rotation link member 67, which is latched with the second locking part 72, is released from the second locking part 72 as the second locking part 72 moves downward.

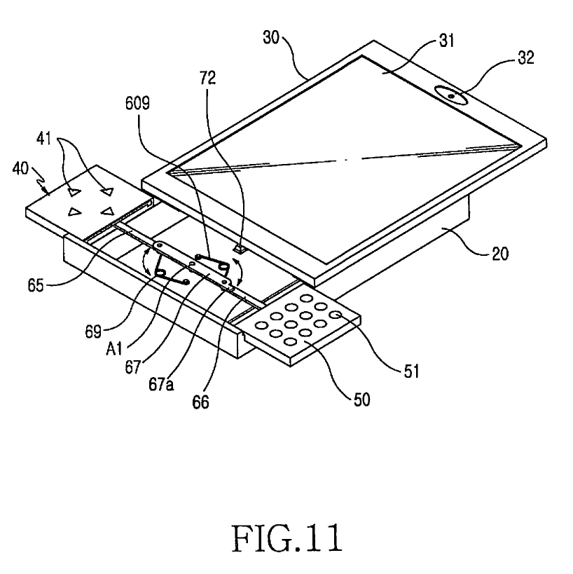

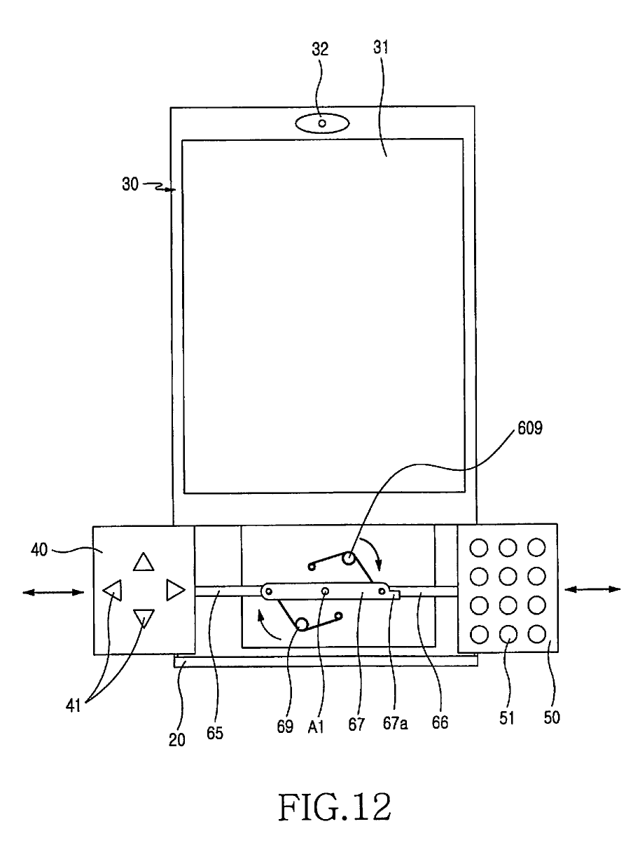

As shown in FIGS. 11 and 12, the rotation link member 67 rotates about the rotational shaft A1 due to elastic force provided by the second and third elastic members 69 and 609, and the rotation link member 67 is rotated from a vertical direction to a transverse direction.

Moreover, the second locking part 72 is again moved upward to the original position by the locking elastic member 73.

At this time, as shown in FIGS. 11 and 12, the rotation link member 67 rotates so that the first and second rotation connecting bars 65 and 66 are rotated. The first and second rotation connecting bars 65 and 66 slide the second and third sliding members 63 and 64 and allow the third and forth housings 40 and 50 to be drawn from both sides of the first housing 20.

As shown in FIG. 12, the second housing 30 slides and the third and fourth housings 40 and 50 are drawn from both sides of the first housing 20 according to the sliding of the second housing.

At this state, as shown in FIGS. 11 to 20, the user can use a four-direction key 41 provided on the third housing 40 and a keypad 51 provided on the fourth housing 50 with both hands.

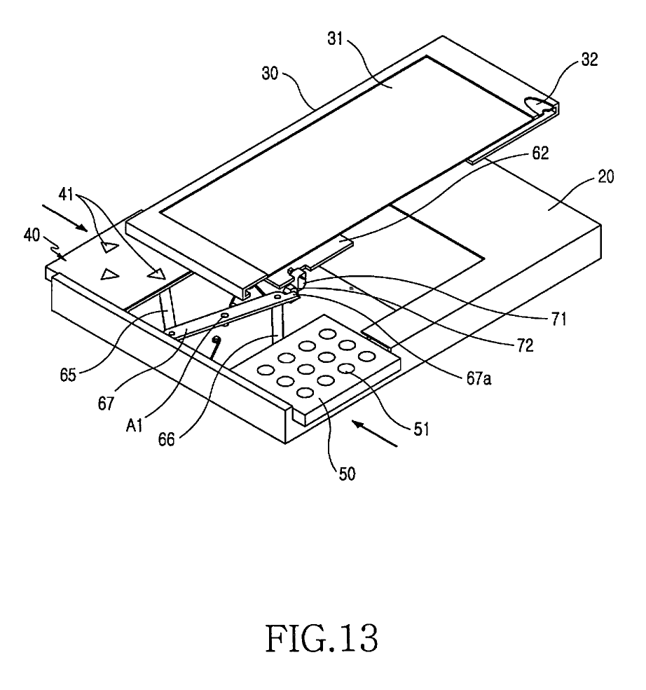

Herein, as shown in FIG. 13, when the second housing 30 slides in a lower direction of the first housing 20 in order to return to its original position, the first sliding member 62 and first locking part 71 slide together with the second housing 30.

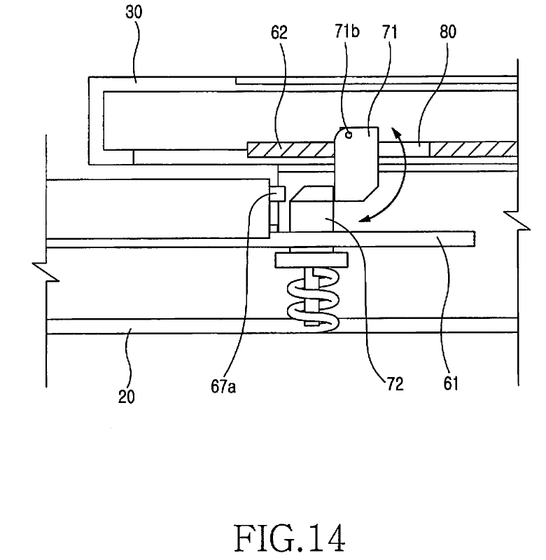

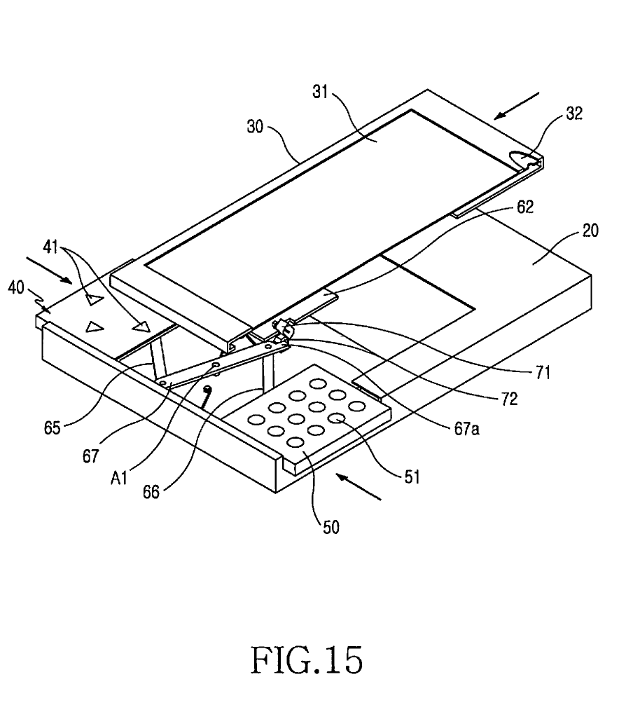

At this time, as shown in FIGS. 14 and 15, the first locking part 71 makes contact with the second locking part 72, and the first locking part 71 is rotated by the locking rotation part 71b and moves along the second locking part 72.

As shown in FIGS. 15 to 18, the locking rotation member 71b includes rotation protuberances 701, and the rotation protuberances 701 are rotatably assembled with a pair of hinge arms 62a formed at the first sliding member 62.

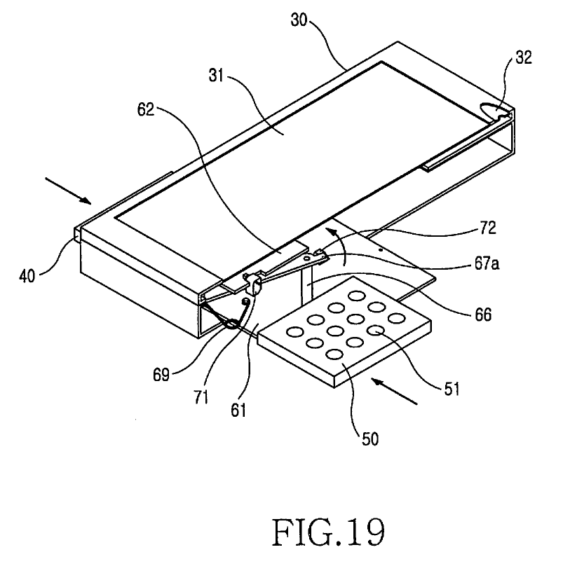

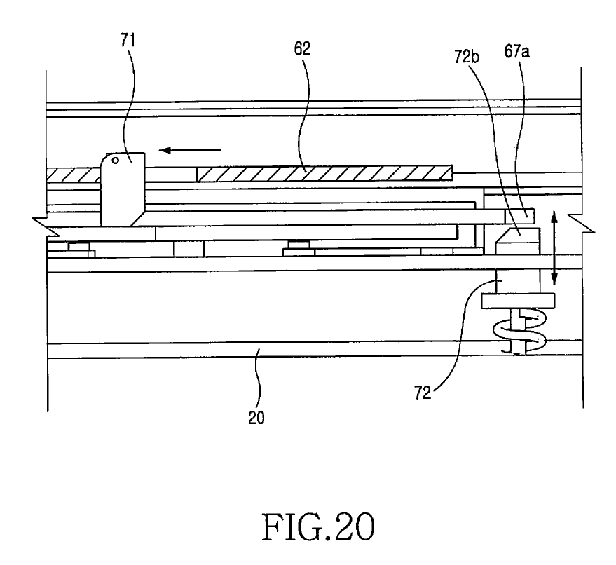

As shown in FIGS. 19 and 20, when the user slides the third and fourth housings 40 and 50, which have been drawn from both sides of the first housing 20, into the interior of the first housing by pushing the third and fourth housings 40 and 50 together, the first and second rotation connection bars 65 and 66 are rotated so that the rotation link member 67 is rotated to be positioned at the original position. While the third and fourth housings 40 and 50 are pushed together, the latching member 67a of the rotation linking member 67 is also rotated, and the latching member 67a makes contact with the second inclined guide surface 72b of the second locking part 72.

As shown in FIGS. 4 and 20, when the latching member 67a is guided along the second inclined guide surface 72b, the second locking part 72 moves from the upper side to the lower side and the latching member 67a is also moved along the second locking part 72. At this time, the second locking part 72 again moves from the lower side to the upper side, and the latching member 67a is locked in the second locking part 72 so that the rotation of the latching member 67a is stopped.

As such, when the second housing 30 slides to its original position, and the third and fourth housings 40 and 50 are pushed inside of the first housing 20, the third and fourth housings 40 and 50 slide into the sides of the first housing 20.

As described above, the portable communication apparatus has a structure where the third and fourth housings are inserted into/drawn from both sides of the first housing when the second housing slides. Therefore, it is possible to implement various shapes of products and allow the products to be used in various fields so that a plurality of keys and a large-sized display device are included in the products. In addition, since a user can operate keys of the apparatus with both hands, the user may conveniently operate keys for inputting text and playing games.

While the invention has been shown and described with reference to certain embodiments thereof, it will be understood by those skilled in the art that various changes in form and details may be made therein without departing from the spirit and scope of the invention as defined by the appended claims.

What is claimed is:

1. A portable communication apparatus comprising:
a first housing;
a second housing slidably assembled with the first housing in a state where the second housing faces the first housing; and
third and fourth housings disposed within the first housing, the third and fourth housings for sliding towards and away from the second housing and for being inserted into and drawn from both sides of the first housing by sliding.

2. The portable communication apparatus as claimed in claim 1, wherein the first housing includes a microphone device, a camera module, and a 3×4 keypad, and the second housing includes a large-sized display device and a speaker.

3. The portable communication apparatus as claimed in claim 1, wherein the third housing includes a four-direction key, a navigation key, a key exclusively used for playing games, and
wherein the fourth housing includes at least one keypad having keys arranged on the keypad.

4. A portable communication apparatus comprising:
a first housing;
a second housing slidably assembled with the first housing in a state where the second housing faces the first housing;
third and fourth housings disposed within the first housing, the third and fourth housings for sliding towards and away from the second housing and for being inserted into and drawn from both sides of the first housing according by sliding;
a module positioned between the first and second housings, the module allowing the second housing to slide and allowing the third and fourth housings to be inserted into/drawn from the first housing according to a sliding of the second housing with respect to the first housing; and
a locking module included in the module, the locking module locking or releasing the third and fourth housings to be inserted into/drawn from the first housing when the second housing slides.

5. The portable communication apparatus as claimed in claim 4, wherein the module comprises:
a base member;
a first sliding member for sliding the second housing from the first housing at a position where the second housing is stacked on the base member;
second and third sliding member allowing the third and fourth housings to be inserted into/drawn from both sides of the first housing at a position where the third and fourth housings are stacked on the base member according to the sliding of the second housing;
first and second rotation connecting bars connected with the second and third sliding members, respectively;
a rotation link member disposed between the sliding members in such a manner that the rotation link member is connected with the rotation connecting bars, wherein the rotation link member is released when the first sliding member slides, the rotation link member rotating about a rotational shaft and rotating the first and second rotation connecting bars, thereby sliding the second and third sliding members;
a first elastic member for providing elastic force to allow the first sliding member to slide; and
second and third elastic members for providing elastic force to allow the rotation link member to rotate.

6. The portable communication apparatus as claimed in claim 5, wherein ends of the first and second rotation connecting bars are rotatably connected with the second and third sliding members, respectively, and each of another end of the first and second rotation bars, respectively, is rotatably connected with the rotation link member.

7. The portable communication apparatus as claimed in claim 5, wherein both ends of the rotation link member are rotatably connected with ends of the first and second rotation connecting bars, respectively, and a latching member, which guides the rotation link member to be locked in or released from the locking module through guiding, is formed at one end of the rotation link member.

8. The portable communication apparatus as claimed in claim 5, wherein one end of the first elastic member is connected with the base member, and another end of the first elastic member is connected with the first sliding member to provide elastic force allowing the first sliding member to slide, and one end of each of the second and third elastic members, respectively, are rotatably connected with a protuberance formed at the base member, and another end of each of the second and third elastic members are connected with the rotation link member so as to allow the rotation link member to rotate due to elastic force.

9. The portable communication apparatus as claimed in claim 5, wherein the locking module comprises:
a first locking part rotatably assembled with the first sliding member, a second locking part disposed on the base member, the second locking part moving upward and downward to be locked in and released, respectively, from the latching member formed on the rotation link member according to contact between the first locking part and the second locking part, when the first locking part slides together with the first sliding member, so that the second and third sliding members are slid to be inserted into/drawn from the first housing; and
a locking elastic member, which is disposed at a lower part of the second locking part and provides elastic force so as to allow the second locking part to move upward or downward.

10. The portable communication apparatus as claimed in claim 9, wherein an inclined movement surface, which is guided along a first inclined guide surface formed on the second locking part so as to press the second locking part downward when the first sliding member slides, is formed at one end of the first locking part, and a locking rotation part, which makes contact with the second locking part and moves along the second locking part while rotating in a case where the first sliding member again slides to its original position, is formed at another end of the first locking part.

11. The portable communication apparatus as claimed in claim 10, wherein the locking rotation part includes a pair of rotation protuberances, which are rotatably connected with a pair of hinge arms formed at the first sliding member.

12. The portable communication apparatus as claimed in claim 9, wherein the second locking part includes:
a first inclined guide surface positioned with an incline of the first inclined guide surface complementary to an incline of the inclined movement surface of the first locking part; and
a second inclined guide surface positioned adjacent to the first inclined guide surface,
wherein the first inclined guide surface is guided to move the second locking part upward or downward when the second locking part makes contact with the inclined movement surface and releasing the second locking part from the latching member of the rotation link member so as to allow the second and third sliding members to be drawn from the first housing,
wherein the second inclined guide surface being guided while making contact with the latching member of the rotation link member so as to move the second locking part upward or downward so that the second locking part is latched in the latching member when the second and third sliding members are inserted into the first housing, and
wherein the second locking part also includes an escape prevention member formed on a lower part of the second inclined guide surface to prevent the second locking part escaping from the base member when the second locking part moves upward or downward, and an elastic guide part formed at a lower part of the escape prevention member to be assembled with the elastic member,

13. The portable communication apparatus as claimed in claim 9, wherein an operational hole, which provides space allowing the first and second locking parts to be operated, is formed at the base member and the first sliding member.
